(19) United States
(12) Patent Application Publication
(10) Pub. No.: US 2015/0183185 A1
(43) Pub. Date: Jul. 2, 2015

(54) COMPOSITE OF METAL AND RESIN AND METHOD FOR MANUFACTURING SAME

(71) Applicant: HON HAI PRECISION INDUSTRY CO., LTD., New Taipei (TW)

(72) Inventor: SHAO-HAN CHANG, New Taipei (TW)

(21) Appl. No.: 14/496,706

(22) Filed: Sep. 25, 2014

(30) Foreign Application Priority Data
Dec. 30, 2013 (CN) 2013107393327

(51) Int. Cl. B32B 5/18; B29C 45/14; B32B 15/08

(52) U.S. Cl. CPC B32B 5/18; B32B 15/08; B29C 45/14795; B32B 2250/02; B32B 2260/046; B29C 2045/14803

(57) ABSTRACT

A composite of metal and resin includes a metal piece and a resin piece combined with the metal piece. A surface of the metal piece defines a plurality of micropores including an upper portion and a lower portion, the upper portion is communicated with the lower portion, and an aperture of the lower portion is larger than an aperture of the upper portion. The lower portion includes an undercut portion. The resin piece is partially embedded into the lower portion and the upper portion of the micropores. A method of manufacturing the composite of metal and resin is also provided.

### FIELD

The subject matter relates to a composite of metal and resin that is composed of a metal and a resin composition suitable for casings of electronic devices, housings of home electric appliances, structural components, machinery parts, for example, and also to a method for manufacturing the composite.

### BACKGROUND

Composite of resin and other materials are used in a wide range of industrial fields including the production of parts for automobiles, domestic electric appliances, industrial machinery, and the like, and a large number of adhesives have been developed therefor. Among them, excellent adhesives have been developed. For example, adhesives demonstrating adhesive functions at normal temperature or under heating are used for integrally joining resin and other materials, and such a method is presently a generally employed joining technology.

### BRIEF DESCRIPTION OF THE DRAWINGS

Implementations of the present technology will now be described, by way of example only, with reference to the attached figures.

FIG. 1 is a cross-sectional view of a first embodiment of a composite of metal and resin.

FIG. 2 a cross-sectional view of an exemplary process for manufacturing a plurality of micropores in a metal piece of the composite of metal and resin as shown in FIG. 1.

FIG. 3 is an partial, cross-sectional view of a machining electrode of FIG. 2.

FIG. 4 is a cross-sectional view of a second embodiment of a composite of metal and resin.

FIG. 5 a cross-sectional view of an exemplary process for manufacturing a plurality of micropores in a metal piece of the composite of metal and resin as shown in FIG. 4.

FIG. 6 is a cross-sectional view of a third embodiment of a composite of metal and resin.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

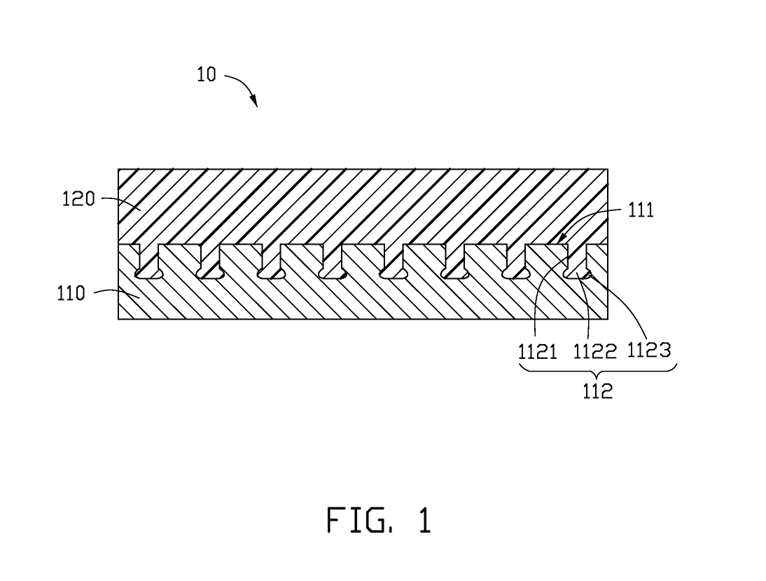

FIG. 1 illustrates a composite 10 of metal and resin of a first embodiment including a metal piece 110 and a resin piece 120 integrated together.

The metal piece 110 can include a surface 111 toward the resin piece 120, and the surface 111 can define a plurality of micropores 112. The micropores 112 can be arranged in an array or in random. The material of the metal piece 110 can be selected from the group consisting of aluminum alloy, magnesium alloy, stainless steel alloy, copper and copper alloy.

The micropores 112 can be substantially T-shaped, and each micropore 112 can include an upper portion 1121 and a lower portion 1122. The upper portion 1121 can be in fluid communication with the lower portion 1122, and an aperture of the lower portion 1122 can be larger than an aperture of the upper portion 1121. In at least one embodiment, the upper portion can be substantially vertical to the surface 111. The lower portion 1122 can be positioned at one side of the upper portion 1121 away from resin piece 120, and the lower portion 1122 can have a larger dimension than the upper portion 1121 to define an undercut portion 1123. The undercut portion 1123 can be substantially circular. In at least one embodiment, the upper portion 1121 and the lower portion 1122 can be substantially circular.

The resin piece 120 can be bonded to the metal piece 110 by inserting molten resin material into a mold (not shown) holding the metal piece 110, wherein the molten resin material is partially embedded into the micropores 112. In detail, the resin piece 120 can be partially embedded into the upper portion 1121 and the lower portion 1122 with the undercut portion 1123. The resin material can be a crystallized-type resin and crystallizes when as it cools. The crystallized-type thermoplastic resin material can be selected from the group consisting of a composite of polyphenylene sulfide and glass fiber, polyamide, polyethylene terephthalate, or polybutylene terephthalate. When using the polyphenylene sulfide and glass fiber composite, the percentage composition of the glass fiber can be in a range from 20 percent to 50 percent.

As the resin piece 120 can be partially embedded into the undercut portions 1123, the composite 10 of metal and resin can have a larger sliding friction than the conventional composite including vertical micropores, allowing an increased bonding strength.

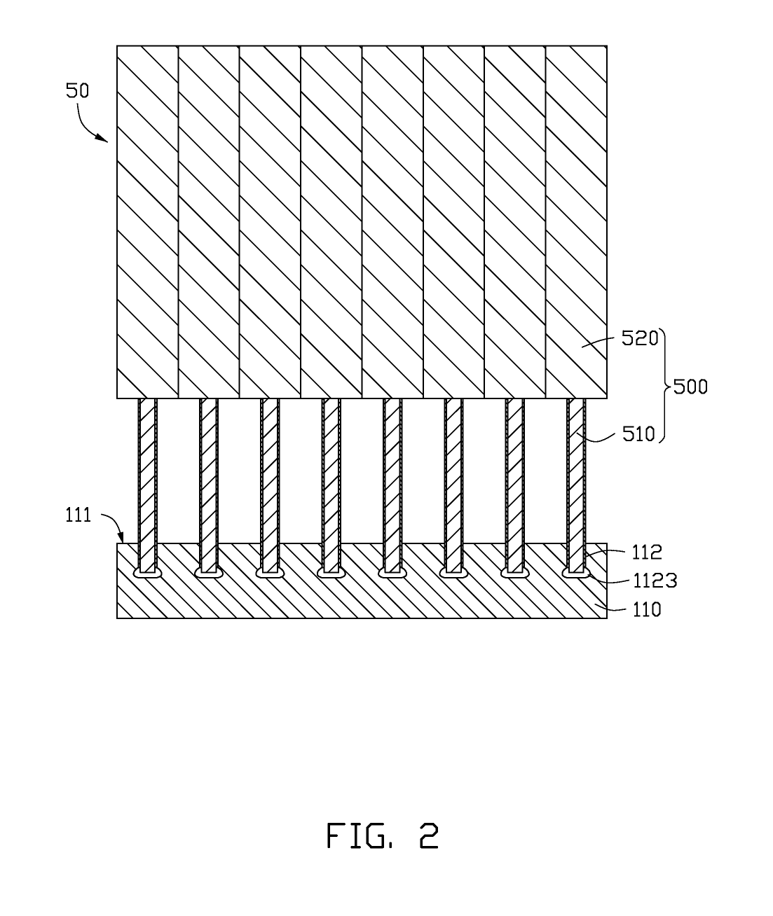

FIG. 2 illustrates an electrode array 50 used to manufacturing the micropores 112 in the metal piece 100. The electrode array 50 can include a plurality of machining electrodes 500. In at least one embodiment, the machining electrodes 500 can be close to each other and arranged in an array, and one end of each of the machining electrodes 500 can form a flat machining surface. In other embodiments, the machining electrodes 500 can be spaced from each other. Each of the machining electrodes 500 can include a machining portion 510 and a clamping portion 520. The clamping portions 520 can kept closely to each other. The machining portion 510 can have a smaller size than the clamping portion 520.

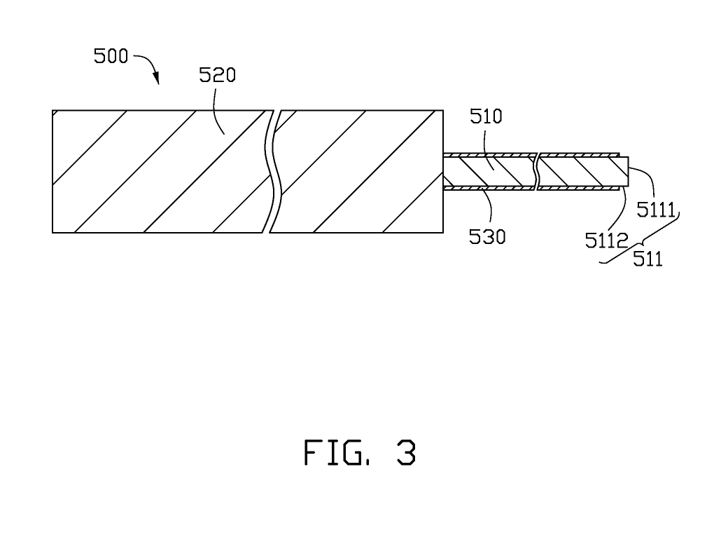

FIG. 3 illustrates that the machining portion 510 can have an end 511 away from the clamping portion 520, and the machining electrode 500 can further include an insulating layer 530 covered on the machining portion 510 except for the end 511. The end 511 can include a bottom surface 5111 and a side surface 5112. As the insulating layer 530 can prevent lateral erosion, the machining portion 500 covered by the insulating layer 530 can be used to process the upper portion 1121 and the lower portion 1122. The bottom surface 5111 and the side surface 5112 of the end 511 can cause lateral erosion, and can be used to process the undercut portion 1123. The machining portions 520 can be, but not limited to, substantially circular.

An example method for manufacturing the composite 10 of metal and resin is provided by way of example, as there are a variety of ways to carry out the method. The method described below can be carried out using the configurations illustrated in FIGS. 1 through 3, for example, and various elements of these figures are referenced in explaining example method.

Firstly, the metal piece 110 after being shaped can be provided and can be cleaned with a degreasing agent solution. Any process, such as machining or casting, can form the metal piece 110.

The metal piece 110 can be positioned at a station of an electrochemical machining apparatus (not shown), and the electrode array 50 can be provided on the top of the metal piece 210. The ends 511 of the machining electrodes 500 can form a flat machining surface parallel with the surface 111 of the metal piece 110. The micropores 112 can be formed by electrochemical machining using the machining electrodes 500. The upper portion 1121 can be formed using the machining portion 510 covered by the insulating layer 530. The lower portion 1122 can be formed using the end 511, while the undercut portions 1123 can be formed by lateral erosion caused by the end 511 of the machining electrode 500.

The metal piece 20 can then be inserted into a mold (not shown), and can be heated to a temperature in a range from 100° C. to 350° C. The heating can be accomplished using electromagnetic induction. After that, molten resin piece 120 can be injected into the mold and onto the metal piece 110. The molten resin piece 120 can be partially embedded in the micropores 122 and bonded with the metal piece 110 when the resin piece 120 is cooled. The composite 10 of metal and resin can then be manufactured.

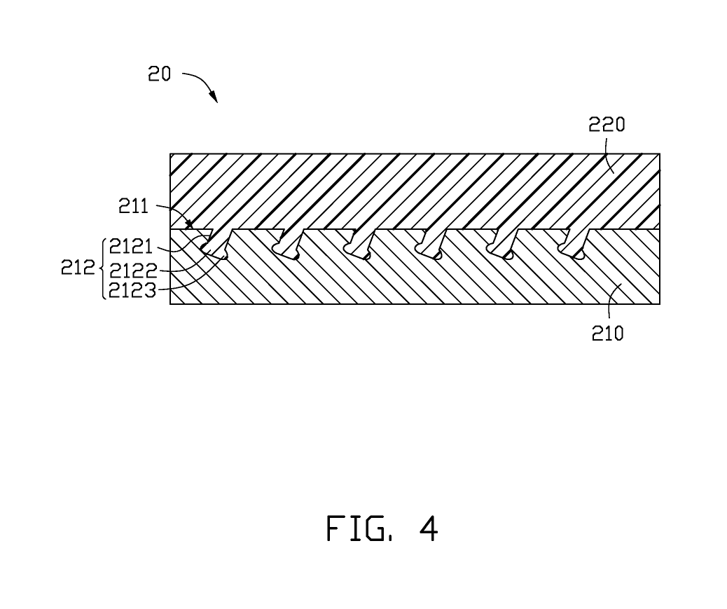

FIG. 4 illustrates a composite 20 in a second embodiment including a metal piece 210 and a resin piece 220. The metal piece 210 can include a surface 211 toward the resin piece 220, and the surface 211 can define a plurality of micropores 212. Each micropore 212 can include an upper portion 2121 and a bottom portion 2122. The lower portion 1122 can be positioned at one side of the upper portion 2121 away from resin piece 220, and can include an undercut portion 2123. The undercut portion 2123 can be circular. The upper portion 2121 can be communicated with the lower portion 2122, and an aperture of the lower portion 2122 can be larger than an aperture of the upper portion 2121. The upper portion 2121 can be oblique to the surface 211. The resin piece 220 can be partially embedded into the micropores 212 to bond with the metal piece 210.

As the micropores 212 can be oblique to the surface 211 of the metal piece 210, the bonding strength between the metal piece 210 and the resin piece 220 can be further increased.

An example method for manufacturing the composite 20 of metal and resin is provided by way of example, as there are a variety of ways to carry out the method. The method described below can be carried out using the configurations illustrated in FIG. 4, for example, and various elements of these figures are referenced in explaining example method.

Firstly, the metal piece 210 after being shaped can be provided and can be cleaned with a degreasing agent solution. Any process, such as machining or casting, can form the metal piece 110.

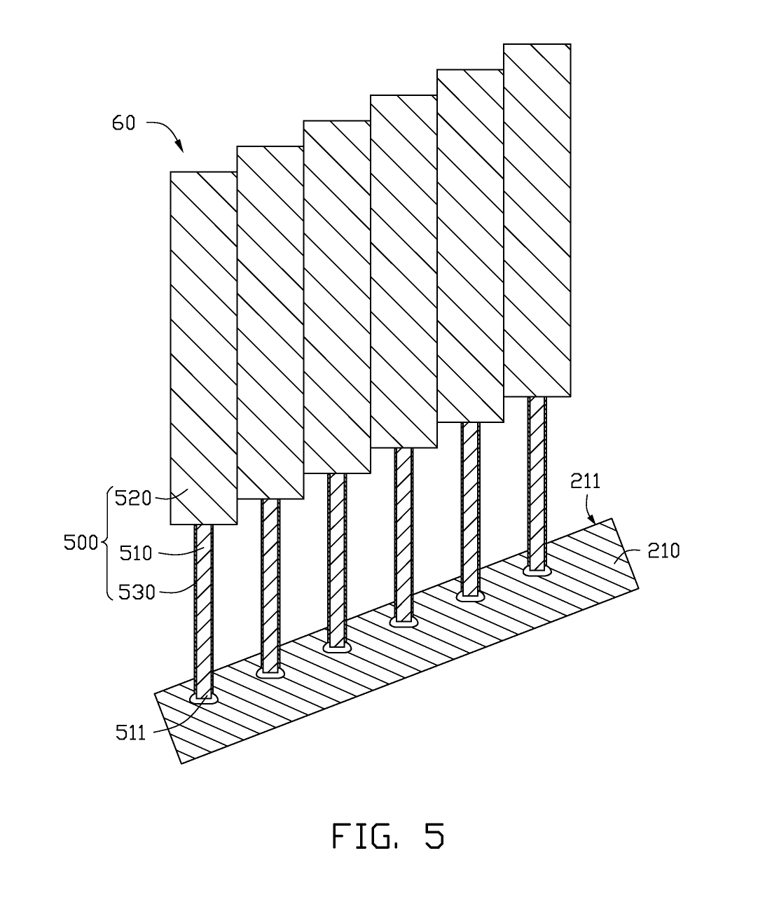

FIG. 5 illustrates that the metal piece 210 can be obliquely positioned to a station of an electrochemical machining apparatus (not shown), and an electrode array 60 can be provided on the top of the metal piece 210. The electrode array 60 can include a plurality of machining electrodes 500 which can be the same as in the first embodiment. The machining electrodes 500 can be arranged in the shape of stairs and oblique to the surface 211 of the metal piece 210. The micropores 212 can be formed by electrochemical machining using the electrode array 60, while the undercut portions 2113 can be formed by the lateral erosion caused by the ends 511 of the machining electrodes 500.

Then, the metal piece 210 can be inserted into a mold (not shown), and can be heated to a temperature in a range from 100° C. to 350° C. After that, molten resin piece 220 can be injected into the mold and onto the metal piece 210. The molten resin piece 220 can be partially embedded in the micropores 212 and bonded with the metal piece 110 when the resin piece 220 is cooled. The composite 20 of metal and resin can then be manufactured.

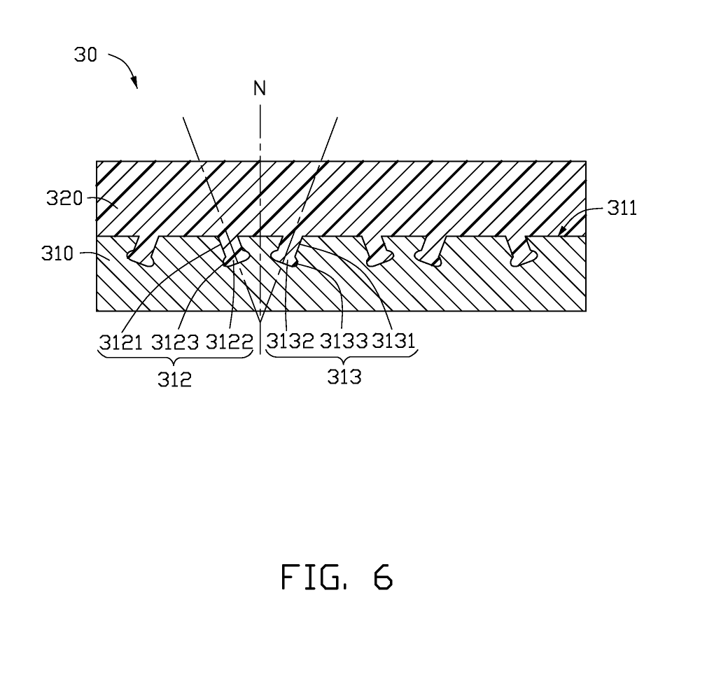

FIG. 6 illustrates a composite 30 in a third embodiment including a metal piece 310 and a resin piece 320. The metal piece 310 can include a surface 311 toward the resin piece 320. The composite 30 of the third embodiment is similar to the composite 20 of the second embodiment, except that the surface 311 can define a plurality of first micropores 312 leaning toward a first direction and a plurality of second micropores 313 leaning toward a second direction.

In at least one embodiment, the first micropores 312 and the second micropores 313 can be arranged symmetrically around an N-axis substantially perpendicular to the surface 311.

In at least one embodiment, the first micropores 312 and the second micropores 313 can be alternatively arranged. In other embodiments, the first micropores 312 and the second micropores 313 can be arranged at two sides of the surface 311, or arranged in random.

A shape of the first micropore 312 and the second micropore 313 can be substantially same as the micropore 212 in the second embodiment. The first micropore 312 can include an upper portion 3121 and a lower portion 3122 with an undercut portion 3123, and the second micropore 313 can include an upper portion 3131 and a lower portion 3132 with an undercut portion 3133.

The manufacturing method for the composite 30 can be substantially same as in the second embodiment, except that, the metal piece 310 can be obliquely positioned at the station of an electrochemical machining apparatus (not shown) toward a first direction, and the first micropores 312 can be formed by electrochemical using a part of the machining electrodes 500 arranged in the shape of stairs. The metal piece 310 can then be obliquely positioned at the station of the toward a second direction, and the second micropores 313 can be formed by electrochemical using another part of the machining electrode 500 arranged in the shape of stairs. In other words, the machining electrodes 500 can be obliquely positioned to the surface 311 of the metal piece 310.

The composite of metal and resin of this disclosure can include a metal piece and the resin piece integrated together, and the metal piece can include a plurality of micropores. The micropore can include the upper portion and the lower portion with an undercut portion, the lower portion has a larger aperture than the upper portion. The resin piece can be partially embedded into the micropores, the combination strength is larger than the conventional composite including vertical micropores. As the micropores can be process by electrochemical machining method, the manufacturing process is simple and the micropores can be evenness.

The embodiments shown and described above are only examples. Many details are often found in the art such as the other features of a composite of metal and resin. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A composite of metal and resin comprising:
a metal piece comprising a surface, and
a resin piece combined with the metal piece;
wherein the surface of the metal piece defines a plurality of micropores, and each of the plurality of micropores comprises an upper portion and a lower portion;
wherein the upper portion is communicated with the lower portion, and an aperture of the lower portion is larger than an aperture of the upper portion;
wherein the lower portion comprises an undercut portion;
wherein the resin piece is partially embedded into the lower portion and the upper portion of the micropores.

2. The composite of metal and resin as claimed in claim 1, wherein the undercut portion is substantially circular.

3. The composite of metal and resin as claimed in claim 1, wherein the micropores are arranged in an array.

4. The composite of metal and resin as claimed in claim 1, wherein the upper portion of the micropores are substantially vertical to the surface of the metal piece.

5. The composite of metal and resin as claimed in claim 1, wherein the upper portion of the micropores are substantially oblique to the surface of the metal piece.

6. The composite of metal and resin as claimed in claim 1, wherein the micropores includes a plurality of first micropores leaning toward a first direction to the surface of the metal piece and a plurality of second micropores leaning toward a second direction to the surface of the metal piece.

7. The composite of metal and resin as claimed in claim 5, wherein the first micropores and the second micropores are arranged symmetrically around an axis perpendicular to the surface.

8. The composite of metal and resin as claimed in claim 1, wherein the upper portion and the lower portion are substantially circular.

9. A method of manufacturing a composite of metal and resin, comprising:
providing a metal piece and cleaning the metal piece with a degreasing agent solution;
providing an electrode array on the top of the metal piece, wherein the electrode array comprises a plurality of machining electrodes, each machining electrode comprises a machining portion with an end, and an insulating layer covered on the machining portion except for the end;
forming a plurality of micropores on one surface of the metal piece by electrochemical machining with the electrode array, wherein the micropores comprises an upper portion and a lower portion, and the lower portion comprises an undercut portion;
inserting the metal piece in an injection mold; and
injecting a molten resin piece on the metal piece, the resin piece combining with the metal piece by partially embedded into the micropores.

10. The method as claimed in claim 9, wherein each machining electrode further comprises a clamping portion connected with the machining portion, and the clamping portions are arranged in an array.

11. The method as claimed in claim 9, wherein the machining portions are substantially circular.

12. The method as claimed in claim 9, wherein the end of the machining portion comprises a bottom surface and a side surface; the undercut portion is formed by lateral erosion corresponding to the side surface of the end.

13. The method as claimed in claim 9, wherein the upper portion is communicated with the lower portion; the upper portion and the lower portion are formed by electrochemical machining using the machining portion covered by the insulating layer.

14. The method as claimed in claim 9, wherein the ends of the machining electrodes are in a plane parallel to the surface of the metal piece, and the upper portions of the micropores are vertical to the surface of the metal piece.

15. The method as claimed in claim 9, wherein the machining electrodes are arranged in the shape of stairs and obliquely positioned to the surface of the metal piece, and the upper portions of the micropores are obliquely positioned to the surface of the metal piece.

16. The method as claimed in claim 9, wherein a part of the machining electrodes are arranged in the shape of stairs and obliquely positioned to the surface, and a plurality of first micropores leaning toward a first direction to the surface are formed; and another part of the machining electrodes are then arranged in the shape of stairs and obliquely positioned to the surface, and a plurality of second micropores leaning toward a second direction to the surface are formed.

17. A structure formed from metal and resin, comprising:
a metal piece comprising:
a surface;
a plurality of micropores defined at the surface, the plurality of micropores comprising an upper portion in fluid communication with a lower portion, the lower portion having a larger dimension than the upper portion to define an undercut portion;
a resin piece that is bonded to the metal piece, the resin piece extending into the lower portion and the upper portion of the plurality of micropores.
